(19) United States
(12) Patent Application Publication
(10) Pub. No.: US 2025/0153074 A1
(43) Pub. Date: May 15, 2025

(54) Air Stripping Device

(71) Applicant: Mike Jupe, West, TX (US)

(72) Inventor: Mike Jupe, West, TX (US)

(21) Appl. No.: 18/837,871

(22) PCT Filed: Feb. 25, 2023
(86) PCT No.: PCT/US2023/013899

§ 371 Date: Aug. 12, 2024

Related U.S. Application Data
(60) Provisional application No. 63/315,415, filed on Mar. 1, 2022.

(51) Int. Cl. B01D 19/00; C02F 1/20; C02F 1/34; C02F 101/10

(52) U.S. Cl. CPC B01D 19/0005; B01D 19/0094; C02F 1/20; C02F 1/34; C02F 2101/10

(57) ABSTRACT

Exerting a continuous flow of solution through fluid conduits and mechanical devices while subjecting the solution to conditions that fluctuate fluid pressure, gas solution supersaturation, stripping gas volume, and fluid conditions to optimize the volumetric mass transfer coefficient decreases the solution's concentration and increases a compound's desorption from solution using the mass transfer coefficient of the compound and air stripping as described by Henry's law.

### CROSS-REFERENCE TO RELATED APPLICATIONS

This application makes reference to U.S. Prov. Pat. App. No. 63/315,415 filed 1 Mar. 2022 and incorporates that document, in its entirety, by reference.

### FIELD OF THE INVENTION

This invention relates to a means of increasing a compound's desorption from solution using the mass transfer coefficient of the compound and air stripping as described by Henry's law. Exerting a continuous flow of solution through fluid conduits and mechanical devices while subjecting the solution to conditions that fluctuate fluid pressure, gas solution supersaturation, stripping gas volume, and fluid conditions to optimize the volumetric mass transfer coefficient decreases the solution's concentration following Henry's law. In this embodiment of the present invention, the compound carbon dioxide in an aqueous solution will be used as the compound to be stripped from the solution. Air will be used as the gaseous stripping agent.

### BACKGROUND OF THE INVENTION

Aspects of the present invention relate to a mechanical means of subjecting a saturated aqueous solution to conditions that improve volatilization and changing the aqueous characteristics or the solution to release compounds with higher vapor pressure and lower aqueous solubility, not limited to, but including, hydrogen sulfide, carbon dioxide, nitrogen, ammonia, volatile organic compounds (VOC's), and carbon dioxide from aqueous solutions in the gaseous phase.

Air stripping, decarbonization, and degasification are terms used. These air stripping, decarbonation, and degasification units are typically large, operate at atmospheric pressure, are detention time dependent, and rely on air passing through atomized water droplets, diffused aeration, and centrifugal and membrane degasifiers to remove carbon dioxide from solution.

Henry's Law of gas solubility defines a proportional relationship between the amount of a gas in a solution and its partial pressure in the atmosphere above the solution. This governs the release of gas from the solution.

The removal of carbon dioxide is an exception to Henry's Law because when water contains carbon dioxide it forms carbonic acid which can ionize into hydrogen and bicarbonate ions. The carbon dioxide that remains in the water that does not form into hydrogen and bicarbonate can be removed by the air stripping, decarbonation, or degasification process. This type of carbon dioxide is called “uncombined” CO₂. The pH, temperature, pressure, and total alkalinity of CaCO₃ of the water affects equilibrium between bicarbonate ions and carbon dioxide in solution. See: D. Lisitsin, et al. Desalination, 222 (2008), pp 50-58 Demonstrating the effect of alkalinity in solution on the CO₂ saturation potential.

Anaerobic digestate, high organic waste processes, desalination, and other streams often contain high concentrations of carbon dioxide with a high alkalinity content. These types of streams can contain a high level of CO₂ that can be stripped by air thus increasing the solution's pH further.

The effectiveness of CO₂ stripping of alkaline conditions high CaCO₃ precipitation

potential is illustrated in the development of alkaline conditions by CO₂ desorption from a solution having the following initial composition:
Total Alkalinity (TAlk)=350 PPM (as CaCO₃)
PH=7.0
Ionic strength=0.036 mol/L
Langelier Saturation Index (LSI)=0.1
   The initial total carbon of this solution is 8.29 mmol/L. It is seen in that desorption of 2 mmol/L of CO₂, which represents less than 25% of the initial total carbon, increases the pH level from 6.9 to 9.0 thereby augmenting the CO₂ concentration by a factor as high as 100.

The end effect is an increase of the supersaturation level by the same factor (from LSI=0.1 to LSI=2.1). The maximum pH level that can be achieved by air stripping of a carbonate solution is restricted by the CO₂ content of ambient air. This limiting condition is given by the equilibrium solubility of CO₂ corresponding to its partial pressure in air. This demonstrates limiting values of pH for solutions having total alkalinities in the range of 250-2500 PPM of CaCO₃.

Two cases are considered: The theoretical case of equilibrium between the solution and the ambient air (e.g. [CO₂] residual/[CO₂] eq˜1) and a more realistic case of partial CO₂ desorption (e.g. [CO₂] residual/[CO₂] eq˜5). Equilibrium desorption of the dissolved CO₂ to the ambient air would induce pH levels higher than 9.0 for solutions having a total alkalinity exceeding 400 PPM (of CaCO₃). Partial desorption of CO₂ can induce pH values higher than 9.0 only for solutions having a total alkalinity exceeding 2500 PPM (of CaCO₃).

Clearly, the residual CO₂ content, which is dictated by the efficiency of the air sparging process, is a crucial design variable. Since the buffer capacity of a carbonate solution increases with the total alkalinity level, the alkali consumption grows significantly with the increase in solution alkalinity. The air flow rate and the corresponding power consumption of the air used for the CO₂ stripping operation depend on mass transfer aspects.

Mass transfer characterization of the air stripping operation was based on the following considerations: 1) The CO₂ stripping process does not alter the value of the total alkalinity. 2) The loss of acidity induced by CO₂ desorption raises the pH and reduces the concentrations of the CO₂ and total carbon content (CT). 3) Since a change in the pH alters the distribution of the carbon species, RCO₂, the specific rate of CO₂ desorption [mol/s m³], is given by the change in CT and not by the change in the CO₂ concentration; e.g. where NCO₂ is the CO₂ desorption rate [mol/s] and VL is the total solution volume.

The kinetics of CO₂ desorption can be characterized by the following overall mass transfer equation based on the liquid phase driving force: Where KL is the overall mass transfer coefficient [m/s]; a is the interfacial area of the air bubbles per unit solution volume (a=AG/VL) [1/m]; [CO₂] bulk is the bulk CO₂ concentration; and, [CO₂] eq is the concentration of CO₂ at equilibrium in a gaseous phase.

Since evaluation of the interfacial area of the bubbles is difficult, it is customary to define the mass transfer in the system by the magnitude of an overall volumetric mass transfer coefficient K=KL a [1/s] which combines the intrinsic mass transfer coefficient with the interphase mass transfer area. Values of K were determined by measuring the pH of the aerated solution versus time. The effectiveness of the CO₂ stripping process in an aeration apparatus can be assessed from the magnitude of K achieved in the system. Major parameters affecting the magnitude of K are the air flow rate and the solution agitation.

### SUMMARY OF THE INVENTION

The invention is intended to be used in a circulating system where reactions occur between components fluidically transported within the system. Such systems may be found in apparatus that process natural gas or serve as a methane gas cleaning system, cleaning leachate from landfill sites, runoff from agricultural land, effluent from industrial processes, industrial process water, municipal water and wastewater, animal wastes, anaerobic digestate, high organic wastes processes, desalination processing, along with natural occurring aqueous solution.

These compounds have relatively high vapor pressure and low aqueous solubility characterized by the compound's Henry's law coefficient. Also, streams often containing high concentrations of carbon dioxide with moderate to high alkalinity content (which may come from a wide range of sources), various prepared solutions, and so on, may be processed using the invention.

The effectiveness of CO₂ stripping depends on the parameters affecting the volumetric mass transfer coefficient of the stripping gas into solution, effective collision efficiency of bubble-particle contact, bubble size and the solutions environment condition sequence that enhance the saturation and releasing of the stripping of CO₂ gas of the solution. Anaerobic digestate, methane gas cleaning water, high organic wastes processes, desalination and other streams often containing high concentrations of CO₂ with moderate to high alkalinity content. These types of streams can contain more CO₂ that can be stripped by air increasing the solution pH further.

### BRIEF DESCRIPTION OF THE DRAWINGS

FIG. 1 is a diagram depicting a first embodiment of the invention.

FIG. 2 is a diagram depicting a second embodiment of the invention.

### DETAILED DESCRIPTION OF THE INVENTION

In the following description, numerous specific details regarding possible componentry (e.g., standard pipe connectors, flanges, centrifugal pumps, venturi injectors) are set forth. Those skilled in the art will recognize, however, that the invention may be practiced apart from these specific details. For example, the invention may be constructed of polyvinylchloride (PVC) pipe, metal pipe, or other structural components and assembled by means of glue or adhesive, welding, fastening, or bolting. All such variations in materials used to construct the present invention are specifically included in the spirit and scope of the disclosure. Similarly, details well known and widely used in the process of fabrication, pipe fitting, equipment assembly (e.g., threading and assembling pipe, plastic injection molding, metal casting techniques for assembling mechanical devices, etc.) and various miscellaneous components have been omitted, so as not to unnecessarily obscure the present invention.

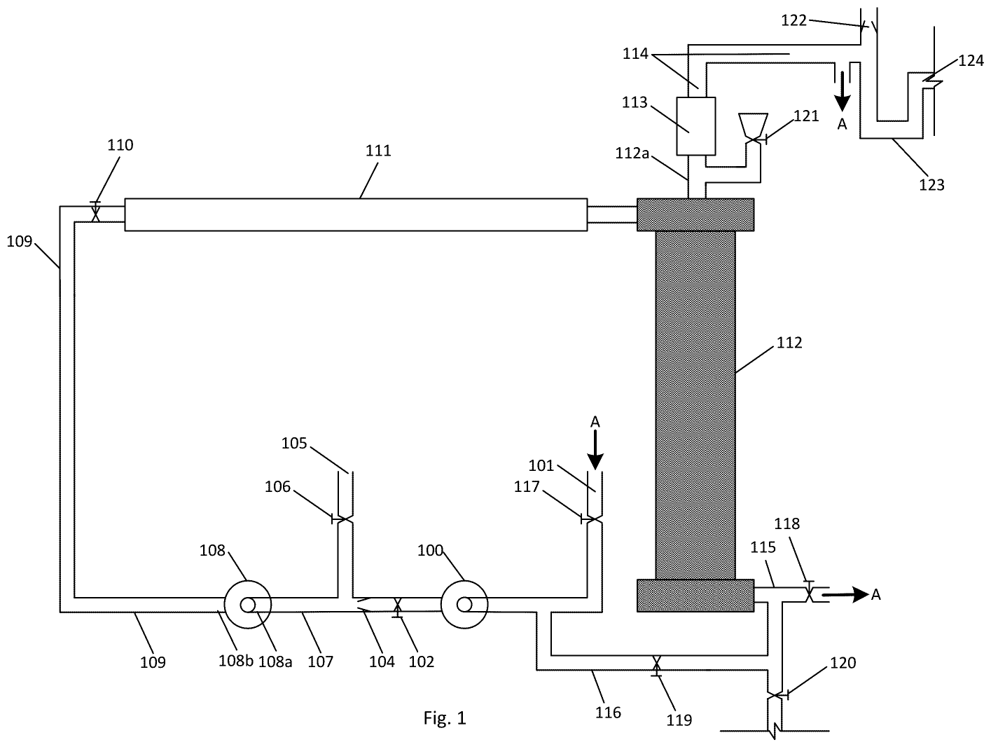

Referring now to FIG. 1, in the CO2 stripping system, influent fluid solution pump 100 is connected to an inlet conduit or pipe 101 externally connected to a separate system (not shown). Isolation valve 117 controls material access at this point. The influent fluid solution pump 100 and flow control valve 102 convey the designed fluid volume and pressure to the venturi injector nozzle 104. The fluid solution moving through the venturi injector nozzle 104 increases in velocity as it passes the constriction. With a corresponding drop in the static pressure, the venturi effect creates the solution vacuum point for the stripping air conduit 105 which supplies the stripping gas to be entrained into the solution stream. The stripping air conduit 105 is fluidically connected through the proportional air flow valve 106. The amount of air flowing through proportional air flow valve 106 is controlled by the pH level of the separate system (at 101).

Following the venturi injector nozzle 104, the fluid continues in fluid conduit 107, at a fluid pressure below the venturi injector pressure, to the air dissolving pump/mixer 108. The lower fluid pressure in fluid conduit 107 increases the injector air inlet volume capacity and air entrainment. The fluid flow provides flooded suction for the air dissolving pump/mixer 108, reducing the fluid in fluid conduit 107 to a condition known as “pump aired” or “air locked” while maintaining flow helping reduce the conditions causing solution foaming. The air dissolving pump/mixer 108 is under low pressure (or high vacuum) condition on the suction side (108a) of the impeller causing cavitation bubbles to implode at the eye and vanes of the impeller. The impeller's high rotation velocity enhances the air (gas) to solution agitation greatly increasing interfacial area of the air (gas) bubbles per unit solution volume.

As the bubbles carry over to the discharge side of the pump/mixer (108b), the fluid conditions change. Compressing bubbles into liquid causes them to also implode. When a pump/mixer's discharge pressure increases, discharge cavitation continues to occur with further bubble implosion. Henry's Law dictates that the amount of gas in the air (gas) entrained in the fluid is directly proportional to pressure, meaning that the higher the pump's pressure the greater amount of air (gas) that can be dissolved into the solution.

Deliverable amounts of air (gas) is based on pressure. Henry's Law dictates that a pressure level of 100 psi will deliver 60% and 39% more gas over pressure levels of 58 psi and 68 psi, respectively. As pressure is increased, bubble size decreases. This is important because the objective of high saturation is the relationship of both the amount of deliverable air (gas) and the size of the bubbles. As the bubble size decreases, the collision efficiency of bubble to particle contact increases.

Equally important is the mass transfer of air (gas) in the liquid phase. This is where shear forces and mixing are important for efficient mass transfer. Under air dissolving pump/mixer 108 discharge pressure this air (gas) mixture becomes supersaturated with micro air (gas) bubbles. Up to 35% air (gas) can be achieved with 100% saturation and micro bubble size smaller than 30 microns.

The air dissolving pump/mixer's pressurized discharge flow continues through conduit 109, to the pressure fluid reducing valve 110 and larger diameter conduit 111 to allow for air (gas) expansion and water separation. The fluid pressure reduction and volumetric space increase causes the dissolved gases, CO₂, and air, to start the separation (desorption) process from aqueous solution and combine with the micro bubble stripping affect.

The fluid flow continues to a separator centrifugal vortex unit 112, that separates entrained and stripping gases from the solution based on the density difference between the gas and liquid. Mazzei Injector Company, LLC, among others, provides a suitable separator centrifugal vortex unit 112. The entrained air and carbon dioxide collect at the vortex of the separator centrifugal vortex unit 112 where they pass through collector 112a and pass-through air relief valve 113 and into air relief vent 114. Air relief vent 114 is sized for the volume of the gas that flows out of the separator centrifugal vortex unit 112.

The stripped solution spins to the outer edges of separator centrifugal vortex unit 112 and flows to the bottom of separator centrifugal vortex unit 112 and into outlet conduit or pipe 115 externally connected to a separate system (not shown) through output valve 118 by means of gravity and/or the suction provided by the separate system (not shown).

Air relief vent 114 has a spray nozzle 122 to dissipate vent foam through the nozzle 122 and conduit p-trap 123 to sewer drain 124. The internal recirculation conduit 116 is fluidically connected between outlet conduit or pipe 115 and inlet conduit or pipe 101. This makes it possible to recycle the stripped solution the system generates more than one time. The internal recirculation conduit 116 is utilized to recirculate the flow within the CO₂ stripping system for the removal of mineral build up within the system.

The cleaning process is accomplished by closing isolation valve 117 and output valve 118 and opening isolation valve 119 and system drain valve 120. System drain valve 120 is closed once the system has been cleaned and drained. Isolation valve 121 is opened and cleaning solution is poured into the open end of isolation valve 121. The isolation valve 121 is then closed and the influent fluid solution pump 100 is activated to circulate the cleaning solution within the system.

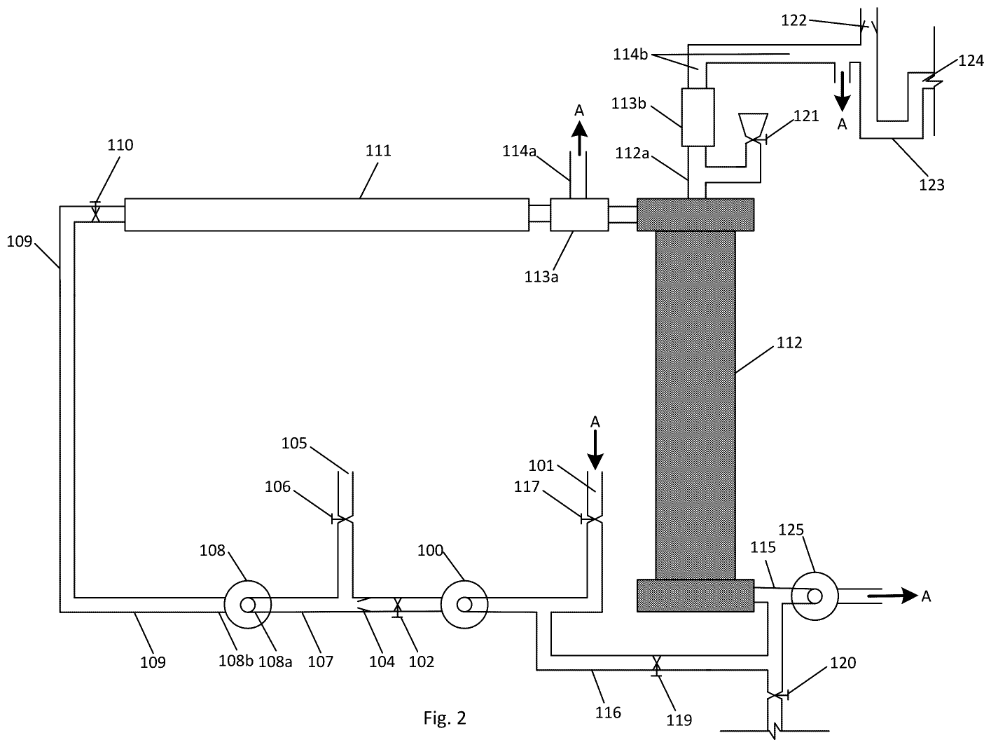

Referring now to FIG. 2, an alternative embodiment of the CO₂ stripping system is shown. In this embodiment of the CO₂ stripping system, influent fluid solution pump 100 is connected to an inlet conduit or pipe 101 externally connected to a separate system (not shown). Isolation valve 117 controls material access at this point. The influent fluid solution pump 100 and flow control valve 102 convey the designed fluid volume and pressure to the venturi injector nozzle 104. The fluid solution moving through the venturi injector nozzle 104 increases in velocity as it passes the constriction. With a corresponding drop in the static pressure, the venturi effect creates the solution vacuum point for the stripping air conduit 105 which supplies the stripping gas to be entrained into the solution stream. The stripping air conduit 105 is fluidically connected through the proportional air flow valve 106. The amount of air flowing through proportional air flow valve 106 is controlled by the pH level of the separate system (at 101).

Following the venturi injector nozzle 104, the fluid continues in fluid conduit 107, at a fluid pressure below the venturi injector pressure, to the air dissolving pump/mixer 108. The lower fluid pressure in fluid conduit 107 increases the injector air inlet volume capacity and air entrainment. The fluid flow provides flooded suction for the air dissolving pump/mixer 108, reducing the fluid in fluid conduit 107 to a condition known as “pump aired” or “air locked” while maintaining flow helping reduce the conditions causing solution foaming. The air dissolving pump/mixer 108 is under low pressure (or high vacuum) condition on the suction side (108a) of the impeller causing cavitation bubbles to implode at the eye and vanes of the impeller. The impeller's high rotation velocity enhances the air (gas) to solution agitation greatly increasing interfacial area of the air (gas) bubbles per unit solution volume.

As the bubbles carry over to the discharge side of the pump/mixer (108b), the fluid conditions change. Compressing bubbles into liquid causes them to also implode. When a pump/mixer's discharge pressure increases, discharge cavitation continues to occur with further bubble implosion. Henry's Law dictates that the amount of gas in the air (gas) entrained in the fluid is directly proportional to pressure, meaning that the higher the pump's pressure the greater amount of air (gas) that can be dissolved into the solution.

Deliverable amounts of air (gas) is based on pressure. Henry's Law dictates that a pressure level of 100 psi will deliver 60% and 39% more gas over pressure levels of 58 psi and 68 psi, respectively. As pressure is increased, bubble size decreases. This is important because the objective of high saturation is the relationship of both the amount of deliverable air (gas) and the size of the bubbles. As the bubble size decreases, the collision efficiency of bubble to particle contact increases.

Equally important is the mass transfer of air (gas) in the liquid phase. This is where shear forces and mixing are important for efficient mass transfer. Under dissolving pump/mixer 108 discharge pressure this air (gas) mixture becomes supersaturated with micro air (gas) bubbles. Up to 35% air (gas) can be achieved with 100% saturation and micro bubble size smaller than 30 microns.

The air dissolving pump/mixer's pressurized discharge flow continues through conduit 109, to the pressure fluid reducing valve 110 and larger diameter conduit 111 to allow for air (gas) expansion and water separation. The fluid pressure reduction and volumetric space increase causes the dissolved gases, CO₂, and air, to start the separation (desorption) process from aqueous solution and combine with the micro bubble stripping affect.

The fluid containing entrained air and carbon dioxide is directed through pass-through air relief valve 113a. Entrained air and carbon dioxide exit by means of air relief vent 114a. Air relief vent 114a is sized for the volume of the gas entrained in the fluid.

The fluid flow continues to a separator centrifugal vortex unit 112, that separates entrained and stripping gases from the solution based on the density difference between the gas and liquid. Mazzei Injector Company, LLC, among others, provides a suitable separator centrifugal vortex unit 112. The entrained air and carbon dioxide collect at the vortex of the separator centrifugal vortex unit 112 where they pass through collector 112a and pass-through air relief valve 113b and into air relief vent 114b. Air relief vent 114b is sized for the volume of the gas that flows out of the separator centrifugal vortex unit 112.

The stripped solution spins to the outer edges of separator centrifugal vortex unit 112 and flows to the bottom of separator centrifugal vortex unit 112 and into outlet conduit or pipe 115 externally connected to a separate system (not shown) by means of an effluent/low pressure control pump 125.

Air relief vent 114b has a spray nozzle 122 to dissipate vent foam through the spray nozzle 122 and conduit p-trap 123 to sewer drain 124. The internal recirculation conduit 116 is fluidically connected between outlet conduit or pipe 115 and inlet conduit or pipe 101. This makes it possible to recycle the stripped solution the system generates more than one time. The internal recirculation conduit 116 is utilized to recirculate the flow within the CO₂ stripping system for the removal of mineral build up within the system.

The cleaning process is accomplished by closing isolation valve 117 and stopping effluent/low pressure control pump 125 while opening isolation valve 119 and system drain valve 120. System drain valve 120 is closed once the system has been cleaned and drained. Isolation valve 121 is opened and cleaning solution is poured into the open end of isolation valve 121. The isolation valve 121 is then closed and the influent fluid solution pump 100 is activated to circulate the cleaning solution within the system.

What is claimed is:

1. An air stripping device wherein an influent fluid solution pump supplies an aqueous solution at increased pressure;
a) whereupon air is injected and mixed into the aqueous solution at the input of a solution pump under negative aqueous pressure conditions:
i) wherein the aqueous solution with a stripping air mixture is subjected to further negative solution pressure forming air bubbles;
ii) wherein the aqueous solution with admixed gas bubbles are mixed with the stripping air mixture;
b) whereupon an air dissolving pump/mixer's high rotational speed causes cavitation in the aqueous solution causing the stripping air bubbles to collapse into micro air bubbles thus increasing the interfacial area of the micro air bubbles per unit of solution volume;
c) whereupon the micro air bubbles absorb gas from the admixed gas bubbles entrained in the aqueous solution;
d) whereupon the aqueous solution with micro air bubbles containing absorbed gas is transported to a large diameter conduit which allows the micro air bubbles containing gas to expand forming a gas;
e) whereupon the gas is released to the atmosphere and the aqueous solution exits the system.

2. An air stripping device of claim 1 wherein the stripping gas is air.

3. An air stripping device of claim 1 wherein the gas follows Henry's law.

4. An air stripping device of claim 3 wherein the gas contains an entrained gas.

5. An air stripping device of claim 1 wherein the gas is released to the atmosphere before the input of a centrifugal vortex unit.

6. An air stripping device of claim 1 wherein the gas is released to the atmosphere after the input of a centrifugal vortex unit.

7. An air stripping device of claim 6 wherein the gas is released by means of a vent.

8. An air stripping device of claim 6 wherein the gas is released by means of a p-trap and a sewer drain.

9. An air stripping device of claim 1 wherein the aqueous solution is drained away from the centrifugal vortex unit by means of gravity and/or separate system suction.

10. An air stripping device of claim 1 wherein the aqueous solution is drained away from the centrifugal vortex unit by means of an effluent/low pressure control pump.

11. An air stripping device wherein the air dissolving pump/mixer impeller's high rotational speed causes cavitation in a fluid greatly increasing the interfacial area of the entrained stripping gas bubbles as they are mixed with the admixed gas bubbles per unit solution volume:
a) which combines the intrinsic mass transfer coefficient with the interphase mass transfer area determining the major parameters affecting:
i) the magnitude of K;
ii) the air flow rate; and
iii) the amount of solution agitation;
b) wherein the fluid flows through one or more air dissolving pump/mixers plumbed in series or in parallel;
i) wherein the aqueous solution with a stripping air mixture is subjected to further negative solution pressure forming air bubbles;
ii) wherein the aqueous solution with admixed gas bubbles are mixed with the stripping air mixture;
iii) whereupon the gas is released to the atmosphere and the aqueous solution exits the system.

12. An air stripping device which has at least one location that separates the desorbed gases from the aqueous solution wherein a larger conduit diameter is insinuated in the system which allows the entrained gas to expand and the fluid to be separated.

13. An air stripping device of claim 12 whereupon gas is released from the aqueous solution to the atmosphere before the input of a centrifugal vortex unit.

14. An air stripping device of claim 12 whereupon gas is released from the aqueous solution to the atmosphere after the input of a centrifugal vortex unit.

15. An air stripping device of claim 12 wherein the aqueous solution is drained away from the centrifugal vortex unit by means of gravity and/or separate system suction.

16. An air stripping device of claim 12 wherein the aqueous solution is drained away from the centrifugal vortex unit by means of an effluent/low pressure control pump.
